(19) United States
(12) Patent Application Publication
(10) Pub. No.: US 2012/0329415 A1
(43) Pub. Date: Dec. 27, 2012

(54) Apparatus and Method for Interference Management

(76) Inventor: Hendricus de Ruijter, Sunnyvale, CA (US)

(21) Appl. No.: 13/170,172

(22) Filed: Jun. 27, 2011

(51) Int. Cl. H04B 17/00

(52) U.S. Cl. 455/226.2

(57) ABSTRACT

A circuit includes a front-end circuit having an input for receiving a radio frequency signal, a control input, and an output. The front-end circuit includes an adjustable gain. The circuit further includes a received signal strength indicator (RSSI) circuit including an input coupled to the output of the front-end circuit and including an output. The circuit also includes a control circuit including an input coupled to the output of the RSSI circuit and an output coupled to the control input of the front-end circuit. The control circuit is configured to iteratively adjust the adjustable gain by a pre-determined adjustment until a difference between a first RSSI measurement and a second RSSI measurement is less than or approximately equal to the pre-determined adjustment.

### FIELD

The present disclosure is generally related to receiver circuits and methods for receiving radio frequency signals, and more particularly to reducing interference in receivers and associated methods.

### BACKGROUND

For any receiver, the sensitivity performance (noise figure) and the inter-modulation performance (3rd order intercept point) present opposing requirements on the design of the receiver. High values of gain, particularly in the front-end of the receiver, achieve relatively high sensitivity but result in relatively poor inter-modulation (IM) performance. Conversely, moderate to low values of front-end gain produce improved IM performance at the expense of sensitivity.

### SUMMARY

In an embodiment, a circuit includes a front-end circuit having an input for receiving a radio frequency signal, a control input, and an output. The front-end circuit includes an adjustable gain. The circuit further includes a received signal strength indicator (RSSI) circuit including an input coupled to the output of the front-end circuit and including an output. The circuit also includes a control circuit including an input coupled to the output of the RSSI circuit and an output coupled to the control input of the front-end circuit. The control circuit is configured to iteratively adjust the adjustable gain by a pre-determined adjustment until a difference between a first RSSI measurement and a second RSSI measurement is less than or approximately equal to the pre-determined adjustment.

In another embodiment, a method for adjusting a gain in a front-end circuit of a receiver includes detecting interference in a signal received at an input of a receiver. The method further includes decreasing a gain of the front-end circuit by a pre-determined adjustment when the interference includes inter-modulation interference and increasing the gain of the front-end circuit by at least the pre-determined adjustment when no inter-modulation interference is detected in the interference.

In another embodiment, a receiver includes a front-end circuit including an input, a control input, an output, the input for receiving a signal. The receiver further includes a received signal strength indicator (RSSI) circuit including an input coupled to the output of the front-end circuit and including an output. The RSSI circuit is configured to provide an RSSI value of the signal to the output of the RSSI circuit. The receiver further includes a controller having an input coupled to the output of the RSSI circuit and an output coupled to the control input of the front-end circuit. The controller iteratively adjusts a gain of the front-end circuit by a pre-determined adjustment until a difference between a first RSSI value and a second RSSI value is less than or approximately equal to the pre-determined adjustment.

### BRIEF DESCRIPTION OF THE DRAWINGS

FIG. 1 is a block diagram of an embodiment of a system including a receiver configured to adjust a gain to reduce inter-modulation interference.

FIG. 2 is a flow diagram of an embodiment of a method of adjusting a gain of a receiver to reduce inter-modulation interference.

FIG. 3 is a flow diagram of an embodiment of a method for determining whether interference in the RF signal is harmful interference.

FIG. 4 is a flow diagram of an embodiment of a method for selectively adjusting a gain of a receiver to reduce inter-modulation interference.

In the following description, the use of the same reference numerals in different drawings indicates similar or identical items. Further, the drawings represent block diagrams to facilitate the discussion and are not intended to show every detail, such as implementation specific details.

### DETAILED DESCRIPTION OF ILLUSTRATIVE EMBODIMENTS

Embodiments of a receiver and methods described in this document make use of the fact that inter-modulation products may not always be harmful. The receiver is configured to determine if inter-modulation products are in the band of interest. If not, the receiver can aggressively reduce the attenuation to a low level, such as zero decibels (0 dB), and the gain of the low noise amplifier can be set to a relatively high level to provide enhanced sensitivity, and the receiver can utilize channel filtering to remove the inter-modulation products. If, however, the inter-modulation products are in the band of interest, the receiver dynamically reduces the gain, which helps to make the front-end circuitry more linear and hence more robust against inter-modulation distortion.

In particular, a receiver includes front-end circuitry including an input for receiving a radio frequency (RF) signal and an output for providing a gain adjusted and filtered signal. The receiver further includes an received signal strength indicator (RSSI) circuit to measure the gain adjusted RF signal to produce an RSSI signal and a controller coupled to the RSSI circuit and to the front-end circuit and configured to selectively adjust a gain of the front-end circuit in response to receiving the RSSI signal.

When the controller detects that there is no harmful interference (i.e., no inter-modulation interference in the band of interest) in the gain adjusted RF signal, the controller adjusts the gain of the front-end circuit to a relatively high level, enhancing sensitivity of the receiver. If the controller detects harmful interference in the gain adjusted RF signal, the controller reduces the gain of the front-end circuit incrementally to make the front-end circuit more linear and robust against inter-modulation distortion. However, if the incremental adjustment does not reduce the RSSI by more than the incremental adjustment, the harmful interference is not inter-modulation noise. In this instance, after a period of time, the controller increases the gain of the front-end circuit. If the incremental adjustment reduces the RSSI by more than the incremental adjustment, the receiver continues adjusting the gain until the RSSI is reduced to a level that is less than or approximately equal to the gain adjustment.

In a particular embodiment, the front-end circuit includes an adjustable attenuator (such as a pin diode or other attenuator) in front of a low-noise amplifier. The adjustable attenuator has an input for receiving the RF signal and an output for providing an attenuated RF signal to an input of a low-noise amplifier (LNA), which provides a gain-adjusted RF signal to a mixer of the receiver. Further, the adjustable attenuator includes a control input for receiving an adjustment signal from a controller. The receiver circuit uses the front-end circuit to take advantage of the effect of the gain adjustment on higher order inter-modulation products. In particular, higher order inter-modulation products are reduced N-times more than the gain reduction of the gain of the front-end circuit, where N represents the order of the inter-modulation product. In an example, a gain reduction of 3 dB produces a 3 dB times N reduction in higher order inter-modulation products at the output of the LNA. In this example, a third order inter-modulation product will be reduced by 9 dB when the gain of the front-end is reduced by 3 dB. However, if such higher order inter-modulation products are not present in the RF signal, a 3 dB adjustment causes a 3 dB reduction in RSSI.

The controller of the receiver is configured to adjust the gain of the front-end circuit in small increments or adjustments (such as 3 dB). The controller compares the RSSI measurements taken before and after applying the gain adjustment, and if the measured RSSI interference is greater than the gain step, the controller determines that the RF signal includes harmful interference. In response to detecting harmful interference, the controller iteratively decreases the gain of the front-end and compares the RSSI to the previous RSSI value until there is no significant difference between the gain step and the measured RSSI difference.

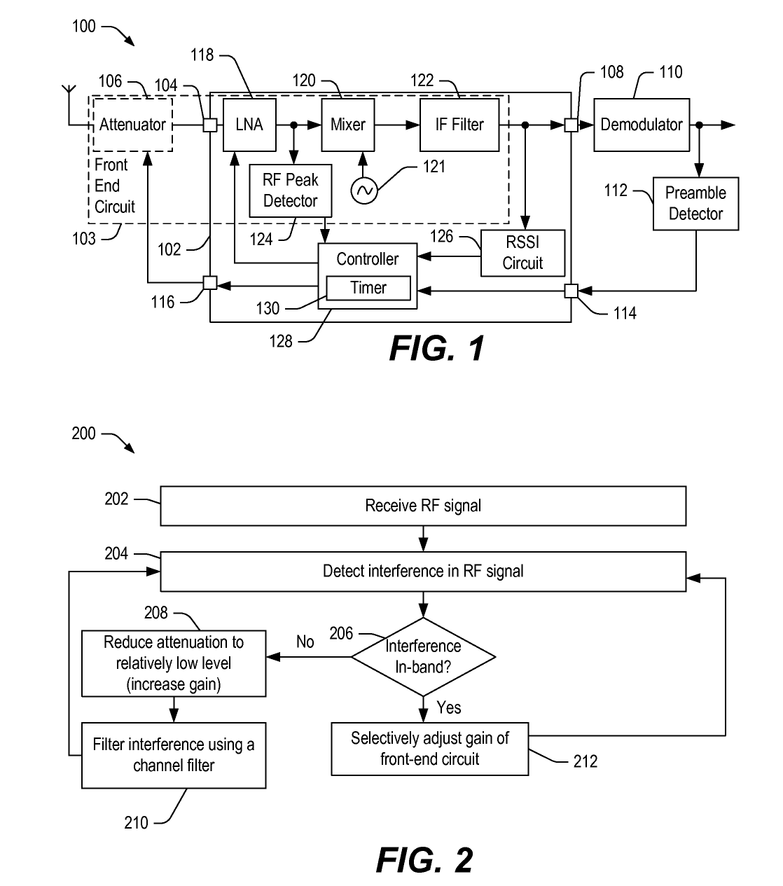

In an example, the receiver periodically checks for harmful interference by altering the gain of the front-end circuit and measuring the RSSI change. In a packet-based transmission system, it may be desirable to adjust the gain of the front-end gain during idle times when no packets are being received. An example of a receiver circuit configured to adjust the front-end gain in response to the RSSI signal is described below with respect to FIG. 1.

FIG. 1 is a block diagram of an exemplary embodiment of a system 100 including a receiver 102 configured to adjust a gain to reduce inter-modulation interference. The illustrated example of FIG. 1 represents one of many possible examples of a system configurable to adjust the gain to reduce inter-modulation interference. The system 100 includes an attenuator 106 having an input coupled to an antenna, an output coupled to an input terminal 104 of receiver 102, and a control input coupled to a control output terminal 116 of receiver 102. Attenuator 106 may be a metal oxide semiconductor field effect transistor (MOSFET) switch or p-intrinsic-n (PIN) diode or another type of passive attenuator that provides high linearity. In some instances, attenuator 106 may be omitted or may be included within receiver 102.

System 100 further includes a demodulator 110 including an input coupled to output terminal 108 and an output for providing a demodulated signal related to an RF signal received at the antenna. System 100 further includes a preamble detector 112 including an input coupled to the output of demodulator 110 and an output coupled to a feedback input terminal 114.

Receiver 102 includes a low-noise amplifier (LNA) 118 having an input coupled to input 104, a control input, and an output coupled to an input of a mixer 120, which has an input for receiving a signal from a local oscillator 121 and an output coupled to an input of an intermediate frequency (IF) filter 122. IF filter 122 can include a programmable gain amplifier and filters and includes an output coupled to the output terminal 108. Receiver 102 further includes an RSSI circuit 126 including an input coupled to the output of IF filter 122 and an output coupled to a first input of a controller 128. Receiver 102 further includes a radio frequency (RF) peak detector 124 including an input coupled to the output of LNA 118 and an output coupled to a second input of controller 128. Controller 128 includes a third input coupled to feedback input terminal 114, a first control output coupled to the control input of LNA 118, and a second control output coupled to control output terminal 116. Controller 128 further includes a timer 130.

In the illustrated example, system 100 includes front-end circuitry 103 that includes at least a portion of receiver 102 (such as LNA 118, mixer 120, optionally local oscillator 121, IF filter 122, and RF peak detector 124) and external attenuation circuitry (such as attenuator 106), if such external attenuation circuitry is provided. Alternatively, in some instances, attenuator 106 may be included within receiver 102 between input terminal 104 and the input of LNA 118. In some instances, in addition to including attenuator 106 within receiver 102, addition circuitry (such as a transformer and/or other circuitry) may also be included between the antenna and input terminal 104.

Controller 128 receives an RF peak detection signal from RF peak detector 124 and receives an RSSI measurement from RSSI circuit 126. Controller 128 controls one of attenuator 106 and LNA 118 to adjust a gain of front-end circuit 103 by a pre-determined adjustment and receives a second RSSI measurement from RSSI circuit 126 in response thereto. If the difference between the RSSI measurements (i.e., the current and previous RSSI measurements) is less than or approximately equal to the pre-determined adjustment of the gain adjustment, controller 128 determines that there is no harmful inter-modulation interference, and controller 128 can control attenuator 106 to reduce the attenuation to a relatively low level or to no attenuation. In a particular instance, attenuator 106 may be omitted or bypassed to provide relatively low attenuation for front-end circuit 103, increasing the sensitivity of receiver 102. In an example, controller 128 initiates timer 130 when the difference is less than or approximately equal to the pre-determined adjustment of the gain adjustment. Once the timer reaches a pre-determined timer threshold, controller 128 receives a third RSSI measurement, adjusts the gain of the front-end circuit 103 by a pre-determined adjustment, and receives a fourth RSSI measurement in response thereto. Controller 128 iteratively increases and/or decreases the gain and compares RSSI measurements until the RSSI difference is less than or approximately equal to the pre-determined adjustment of the gain adjustment. Thereafter, controller 128 periodically captures an RSSI measurement from RSSI circuit 126, adjusts the gain of front-end circuit 103, captures another RSSI measurement, determines whether inter-modulation interference is present, and repeats the above-process.

Controller 128 takes advantage of the fact that higher order inter-modulation products are reduced N times more than the gain reduction of front-end circuit 103, where N is the order of the inter-modulation product. In an example, a third-order inter-modulation product will be reduced by nine decibels (9 dB) when the gain of front-end circuit 103 is reduced only three decibels (3 dB). Controller 128 reduces the gain of front-end circuit 103 by a small amount (e.g., 3 dB) and receives the RSSI measurement before and after the gain adjustment. If the measured RSSI difference is significantly greater than the gain adjustment, one or more inter-modulation products have reached the input of demodulator 110, which one or more inter-modulation products constitute “harmful interference.” In response to detecting harmful interference, controller 128 reduces the gain of front-end circuit 103 incrementally until there is no significant difference between the gain adjustment and the measured RSSI difference. In an example, when the measured RSSI difference is less than or approximately equal to the gain adjustment, the difference is not significant because further adjustment to the attenuation will not further improve the signal-to-noise ratio. Once the controller 128 reaches this state, controller 128 can stop adjusting the gain and can periodically check if the harmful interference is increased or reduced by reducing or increasing the gain and measuring the RSSI change.

In some instances, receiver 102 includes an automatic gain control (AGC) circuit. In this instance, the front-end gain (i.e., the maximum front-end gain) of the receiver 102 can be adjusted and/or limited according to the aforementioned algorithm. An example of a method of adjusting the gain of a receiver to reduce inter-modulation interference is described below with respect to FIG. 2.

FIG. 2 is a flow diagram of an embodiment of a method 200 of adjusting a gain of a receiver to reduce inter-modulation interference. At 202, receiver 102 receives an RF signal. Advancing to 204, controller 128 detects interference in the RF signal. In an example, controller 128 detects interference by capturing a first RSSI measuring, adjusting a gain, capturing a second RSSI measurement, and comparing the difference between the first and second RSSI measurements to the gain adjustment. If the difference is less than or approximately equal to the gain adjustment, the interference is not in-band and can be readily filtered by a channel filter. Otherwise, if the difference is greater than the gain adjustment, controller 128 determines that the interference is in-band and is therefore harmful interference.

Advancing to 206, if the interference is in-band, the method 200 advances to 212 and controller 128 selectively adjusts the gain of the front-end circuit 103. The method 200 returns to 204 and controller 128 looks for interference in the RF signal.

Otherwise, at 206, if the interference is not in-band, the method 200 advances to 208 and controller 128 reduces the attenuation to a relatively low level (increasing the adjustable gain of front-end circuit 103). Continuing 210, receiver 102 filters the interference using a channel filter, for example. The method 200 returns to 204 and controller 128 looks for interference in the RF signal.

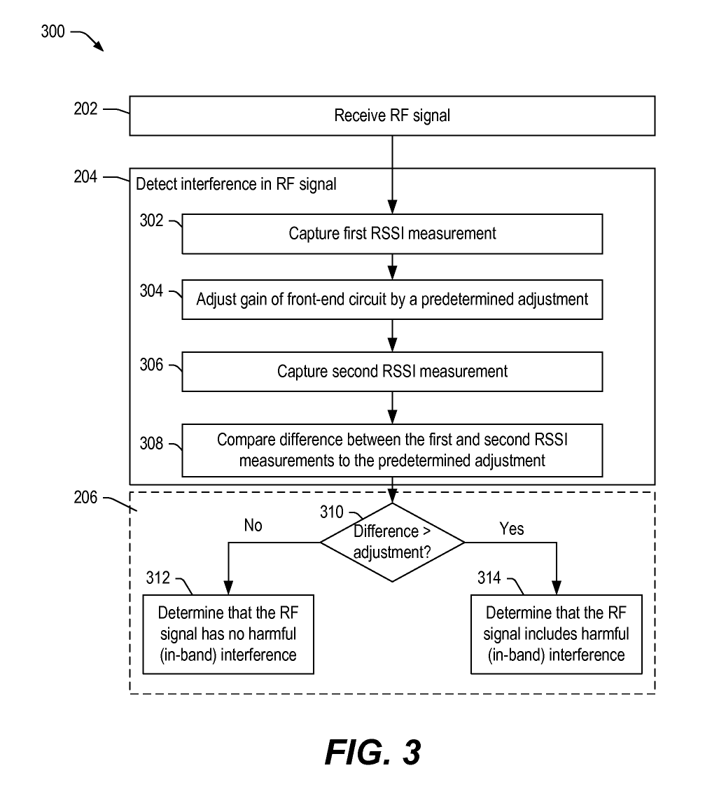

In an example, receiver 102 makes use of the fact that higher order inter-modulation products are reduced N times more than the gain reduction of the front-end circuitry 103, where N is the order of the inter-modulation product. Thus, a third order inter-modulation product will be reduced by 9 dB when the gain of the front-end circuit 103 is reduced only 3 dB. An example of a method for determining whether interference in the RF signal is harmful is described below with respect to FIG. 3.

FIG. 3 is a flow diagram of an embodiment of a method 300 for determining whether interference in the RF signal is harmful is described below with respect to FIG. 3. At 202, receiver 102 receives an RF signal. Advancing to 204, controller 128 detects interference in the RF signal. In the illustrated example, detecting interference in the RF signal includes capturing a first RSSI measurement (at 302). Advancing to 304, controller 128 adjusts the gain of front-end circuit 103 by a pre-determined adjustment. Proceeding to 306, controller 128 captures a second RSSI measurement. Moving to 308, controller 128 compares the difference between the first and second RSSI measurements to the pre-determined adjustment.

Continuing to 206, the controller determines if the interference is in-band or not. At 310, if the difference is less than or approximately equal to the pre-determined adjustment, the method 300 advances to 312 and controller 128 determines that the RF signal has no harmful (in-band) interference. Otherwise, if the difference is greater than the pre-determined adjustment at 310, the method 300 advances to 314 and controller 128 determines that the RF signal includes harmful (in-band) interference.

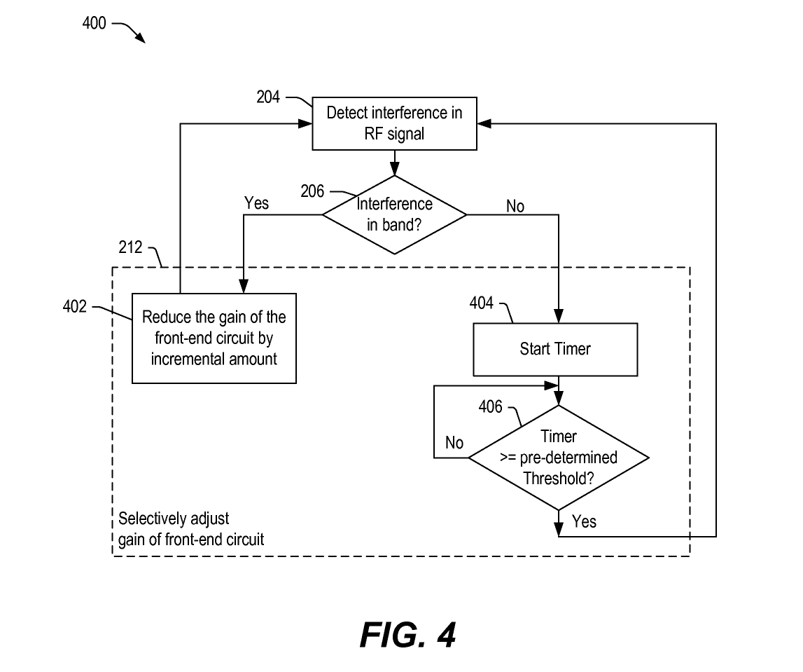

As mentioned above, if the difference is less than or equal to the pre-determined adjustment, controller 128 may reduce the attenuation of front-end circuitry 103 to increase (or maximize) the gain. An example of a method of adjusting the gain to reduce inter-modulation effects is described below with respect to FIG. 4.

FIG. 4 is a flow diagram of an embodiment of a method 400 for selectively adjusting a gain of a receiver to reduce inter-modulation interference. At 204, controller 128 detects interference in the RF signal. Advancing to 206, if the controller 128 determines that the interference is in-band, the method 400 advances to 402 and controller 128 selectively adjusts the gain of the front-end circuit 103. The method 400 then returns to 204 and controller 128 detects interference in the RF signal.

If the interference is determined not to be in-band, the method 400 advances to 404 and controller 128 starts a timer. Advancing to 406, if elapsed time of the timer is less than a pre-determined threshold, the method 400 continues to monitor the timer until the timer is equal to or exceeds the pre-determined threshold. At 406, when the timer is equal to or exceeds the pre-determined threshold, the method 400 returns to 204 and controller 128 detects interference in the RF signal.

In conjunction with the system and methods described above with respect to FIGS. 1-4, a receiver 102 includes a front-end circuit 103 having an adjustable attenuation, an RSSI circuit 126, and a controller 128 configured to selectively adjust the attenuation of the front-end circuit 103. In an example, controller 128 captures a first RSSI measurement, adjusts the attenuation by a pre-determined adjustment, captures a second RSSI measurement, and selectively adjusts the attenuation based on a comparison of the difference between the RSSI measurements and the pre-determined adjustment. If the difference is less than or equal to the pre-determined adjustment, controller 128 determines that any inter-modulation interference is not in-band and reduces the attenuation by the pre-determined adjustment to enhance the receiver's sensitivity. If the difference is greater than the pre-determined adjustment, controller 128 increases the attenuation, captures another RSSI measurement, and compares the difference between the RSSI measurements to the pre-determined adjustment again to determine whether the interference is in-band.

Although the present invention has been described with reference to preferred embodiments, workers skilled in the art will recognize that changes may be made in form and detail without departing from the scope of the invention.

What is claimed is:

1. A circuit for receiving a radio frequency signal, the circuit comprising:
a front-end circuit including an input for receiving the radio frequency signal, a control input, and an output, the front-end circuit having an adjustable gain between the input and the output;
a received signal strength indicator (RSSI) circuit including an input coupled to the output of the front-end circuit and including an output; and
a controller including an input coupled to the output of the RSSI circuit and an output coupled to the control input of the front-end circuit, the controller configured to iteratively adjust the adjustable gain by a pre-determined adjustment until a difference between a first RSSI measurement and a second RSSI measurement is less than or approximately equal to the pre-determined adjustment.

2. The circuit of claim 1, wherein:
the front-end circuit comprises a passive attenuator having an adjustable attenuation; and
the controller adjusts the adjustable gain by adjusting the adjustable attenuation of the passive attenuator by the pre-determined adjustment.

3. The circuit of claim 1, wherein:
the front-end circuit comprises a low-noise amplifier (LNA) having an adjustable gain; and
the controller adjusts the adjustable gain by adjusting the adjustable gain of the low-noise amplifier by the pre-determined adjustment.

4. The circuit of claim 1, wherein the controller detects interference in the radio frequency signal when the difference exceeds the pre-determined adjustment.

5. The circuit of claim 4, wherein the controller adjusts the adjustable gain of the front-end circuit periodically and captures a current RSSI measurement for determining a difference between a previous RSSI measurement and the current RSSI measurement to detect when the interference includes inter-modulation interference.

6. The circuit of claim 4, wherein the controller decreases the adjustable gain by the pre-determined adjustment in response to detecting the inter-modulation interference in the radio frequency signal.

7. The receiver of claim 4, wherein the controller increases the adjustable gain when no inter-modulation interference is detected.

8. A method for adjusting a gain in a front-end circuit of a receiver, the method comprising:
detecting interference in a signal received at an input of a receiver;
decreasing a gain of the front-end circuit by a pre-determined adjustment when the interference includes inter-modulation interference; and
increasing the gain of the front-end circuit by at least the pre-determined adjustment when no inter-modulation interference is detected in the interference.

9. The method of claim 8, wherein the inter-modulation interference includes inter-modulation distortion that is in-band.

10. The method of claim 8, wherein decreasing the gain of the front-end circuit reduces higher order inter-modulation distortion by an amount that is N times the pre-determined adjustment, where N represents an order of an inter-modulation product.

11. The method of claim 8, wherein detecting for the interference in the signal comprises:
measuring a first value of a received signal strength indicator (RSSI) signal corresponding to the signal;
adjusting the gain of the front-end circuit by the pre-determined adjustment;
measuring a second value of the RSSI signal corresponding to the signal; and
comparing a difference between the first value and the second value to the pre-determined adjustment; and
wherein the interference is detected when the difference exceeds the pre-determined adjustment.

12. The method of claim 11, further comprising increasing an attenuation of the front-end circuit by the pre-determined adjustment when the difference is greater than the pre-determined adjustment.

13. The method of claim 11, further comprising reducing an attenuation of the front-end circuit by at least the pre-determined adjustment when the difference is less than or approximately equal to the pre-determined adjustment.

14. The method of claim 8, wherein decreasing a gain of the front-end circuit by a pre-determined adjustment comprises at least one of increasing an attenuation of a passive attenuator of a front-end circuit and decreasing an adjustable gain of a low-noise amplifier of the front-end circuit.

15. The method of claim 8, further comprising iteratively decreasing the gain of the front-end circuit by the pre-determined adjustment with until a difference between the first value and the second value of the RSSI signal is less than or approximately equal to the pre-determined adjustment.

16. A receiver comprising:
a front-end circuit including an input, a control input, an output, the input for receiving a signal;
a received signal strength indicator (RSSI) circuit including an input coupled to the output of the front-end circuit and including an output, the RSSI circuit configured to provide an RSSI value of the signal to the output of the RSSI circuit; and
a controller including an input coupled to the output of the RSSI circuit and an output coupled to the control input of the front-end circuit, the controller to iteratively adjust a gain of the front-end circuit by a pre-determined adjustment until a difference between a first RSSI value and a second RSSI value is less than or approximately equal to the pre-determined adjustment.

17. The receiver of claim 16, wherein the controller reduces the gain of the front-end circuit by the pre-determined adjustment when the difference is greater than the pre-determined adjustment.

18. The receiver of claim 16, wherein the controller increases the gain of the front-end circuit when the difference is less than or equal to the pre-determined adjustment.

19. The receiver of claim 18, wherein the front-end circuit comprises a passive attenuation element; and
wherein the controller increases the gain of the front-end circuit by decreasing the attenuation of the passive attenuation element to approximately no attenuation.

20. The receiver of claim 18, wherein:
the controller includes a timer;
the controller initializes the timer when the difference is less than or equal to the pre-determined adjustment and, in response to the timer exceeding a threshold, the controller adjusts the gain by the pre-determined adjustment, receives a current RSSI measurement; and
the controller compares the difference between the current RSSI measurement and a previous RSSI measurement to the pre-determined adjustment to determine if the signal includes the harmful interference.
